(19) United States
(12) Patent Application Publication
(10) Pub. No.: US 2024/0298737 A1
(43) Pub. Date: Sep. 12, 2024

(54) High Performance Rubber Components Using Recycled Rubber and Methods of Making and Using Same

(71) Applicant: Trederra LLC, Portsmouth, NH (US)

(72) Inventors: John Healy, Madbury, NH (US); Anthony Thomas Marino, Kittery, ME (US); Matthew Wayne Pennington, Stratham, NH (US)

(73) Assignee: Trederra LLC, Portsmouth, NH (US)

(21) Appl. No.: 18/598,267

(22) Filed: Mar. 7, 2024

Related U.S. Application Data
(60) Provisional application No. 63/489,213, filed on Mar. 9, 2023.

(51) Int. Cl. A43B 1/12; A43B 13/04; C08L 17/00

(52) U.S. Cl. CPC A43B 1/12; A43B 13/04; C08L 17/00; C08L 2205/025; C08L 2310/00

(57) ABSTRACT

A footwear outsole created partially from a preferred recycled rubber consisting of a rubber powder of a high surface to area to volume ratio. The recycled rubber is created via a fully mechanical process and devulcanized without the use of chemicals. When mixed and re-vulcanized into new rubber, the surface area to volume ratio of the recycled rubber particles produce a rubber that mixes well with virgin rubber and results in a compound with excellent physical parameters. The recycled rubber powder has rubber particles that are preferably of a size between 250 and 1000 micrometers. Consumer products such as footwear outsoles, produced using the preferred recycled rubber mixed with virgin rubber display excellent physical properties for the intended use of footwear outsoles.

### RELATED APPLICATIONS

The present application claims priority to U.S. Ser. No. 63/489,213, filed Mar. 9, 2024, the disclosure of which is hereby incorporated by reference in its entirety as if fully set forth herein.

### FIELD OF THE DISCLOSURE

This present disclosure relates generally to the use of reclaimed rubber and the processes for forming the reclaimed and recycled rubber into new consumer products such as footwear outsoles. More particularly, the present disclosure relates to devices and methods that use recycled rubber without devulcanization processes that rely on chemicals.

### BACKGROUND OF THE DISCLOSURE

The reclaiming and reuse of rubber is an important process that can have large environmental benefits. The auto and truck industry alone produces 800,000 metric tons of rubber products per annum in the form of tires and tubes. Additionally, the production of general rubber goods brings the total use of rubber to over 1 million metric tons per year. The ability to recycle this rubber is an important environmental step however, the efficiency and overall environmental benefit of today's rubber recycling is less than desired.

The strong chemical bonds that form during rubber vulcanization and give products molded from virgin rubber their desired mechanical properties are difficult to break. Devulcanization of recycled rubber often includes the use of chemicals, thereby reducing the environmental advantage as added chemicals serve to add more environmental challenges. Moreover, when typical recycled rubber products are reformed (re-vulcanized), the resulting physical properties are normally much lower than virgin rubber due to poor bonding of the recycled rubber and virgin rubber in the new compound.

An improved recycled rubber with better mixing, bonding, and physical properties is disclosed below.

### SUMMARY OF THE DISCLOSURE

In some embodiments, a footwear outsole includes a blend of virgin and recycled rubber formed of recycled rubber particles, the recycled rubber content loading rate being greater than 15%.

In some embodiments, a method of manufacturing a footwear outsole includes providing a virgin rubber, obtaining recycled rubber and mechanically devulcanizing the recycled rubber via a high-pressure water jet to form recycled rubber particles, and mixing the recycled rubber particles with the virgin rubber, the recycled rubber content loading rate being greater than 15%.

### BRIEF DESCRIPTION OF THE DISCLOSURE

Various embodiments of the presently disclosed devices and methods are shown herein with reference to the drawings, wherein:

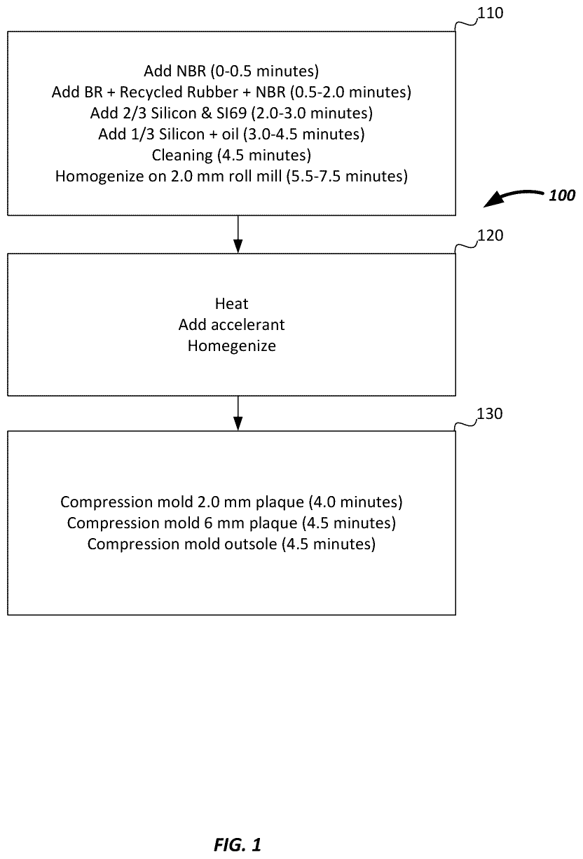

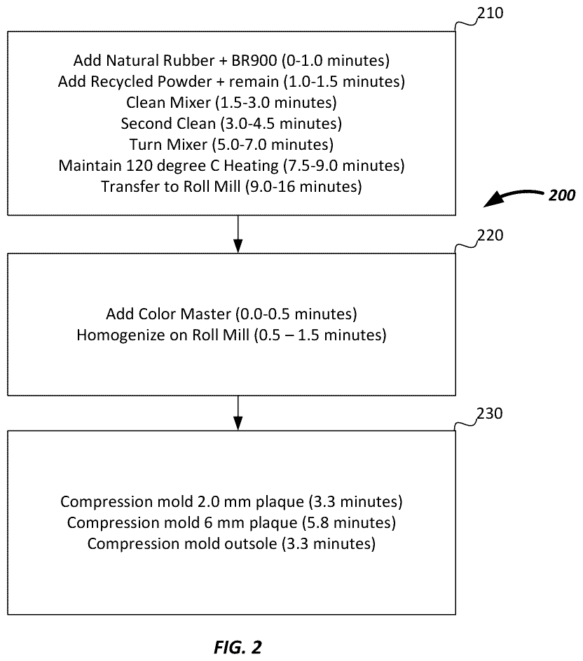

FIGS. 1-2 are flowcharts showing methods of making articles of reclaimed rubber;

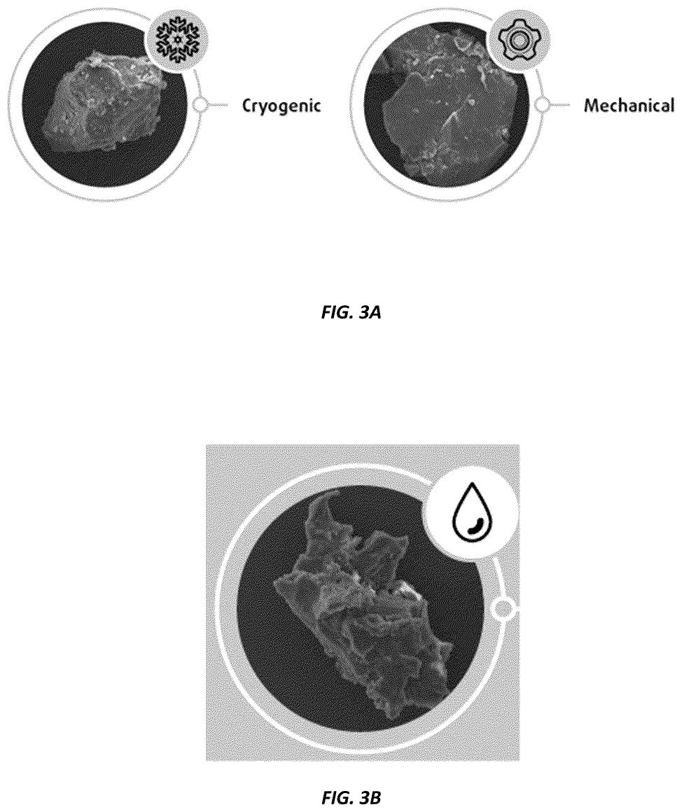

FIG. 3A is an example of a standard devulcanized rubber particle; and

FIG. 3B is an example of a rubber particle with a high surface area-to-mass ratio.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to reclaimed rubber products and methods of manufacture, conventional devices and methods suffer from some shortcomings.

As used herein, the term “virgin rubber” refers to rubber and blends of rubber that are not derived from recycled rubber products. For example, rubber used in conventional consumer products such as footwear outsoles are often a blend of different types of rubber including Styrene-Butadien Rubber (SBR), Butadien Rubber (BR), Isoprene rubber, Nitril-Butadien rubber (NBR), Butyl Rubber (BR), and Natural Rubber (NR). With the exception of Natural Rubber which is made from the sap of a rubber tree, rubber is synthetic and derived from petroleum and chemicals. One familiar in the art of rubber compounding will understand that rubber blends of varying composition are created to optimize physical properties for the intended use. For instance, footwear outsoles designed for work shoes that are required to be fuel resistant will have a higher concentration of NBR. Outsoles designed for casual use will typically use a blend of NR, SBR, and BR. The recipes for the different rubber blends will vary based on required physical properties, environmental concerns, and required costs but will almost always be a combination of different rubber types.

Conventional rubber recycling consists of grinding rubber products (e.g., tires) to a crumb and then applying a sequence of chemical and mechanical manipulation(s) to devulcanize the rubber by cleaving the sulfur bonds (S—S) in the vulcanized rubber. The breaking of the sulfur bonds prepares the rubber for re-vulcanization where the sulfur molecules are rejoined through the heat and pressure of the vulcanization process.

Sekhar et al. (U.S. Pat. No. 5,770,632) disclosed a chemistry of specific zinc salts, thiurams, guanidines, sulphenamides and zinc oxide activators combined with mechanical manipulation that can successfully cleave sulfur bonds at temperatures below 70 C. This process is simple enough to be applied in a rubber compounding factory at material temperatures commonly found in rubber manufacturing, making it a practical solution. However, the quality of the devulcanized rubber limits its use in new products and the recycled content used in new products is often less than 20% of the weight of the new product. Moreover, the physical properties of the final rubber including tensile, elongation, resistance to wear, and to some extent the visual appearance on the surface of products molded from the recycled rubber is less than desirable.

U.S. Pat. No. 5,672,630 discloses a process for devulcanizing rubber via a combination of mastication and a devulcanizing agent. The devulcanizing agent can be a chemical such as diaryldisulfide, dixylydisufide, phenylhydrazine-ferrous chloride, thiophenol-butylamine salt, and other non-specified chemicals that serve to chemically decouple sulfur bonds. The chemical loosens the sulfur bonds and the mechanical mastication breaks the bonds, setting up the rubber for re-vulcanization in a later step.

Other methods for devulcanization that rely on chemicals are described in the art. U.S. Pat. No. 6,462,009 discloses rubber devulcanization through the use of butanol as a chemical destabilizer. The rubber is then devulcanized through added heat and pressure. U.S. Pat. No. 5,602,186 discloses a process for devulcanization by mixing a solvent and alkali metal in a heated, anaerobic reaction. This process thermally cracks the rubber and devulcanizes the bonds. U.S. Pat. No. 5,597,851 discloses the use of thiophyllic microbes or enzymes from thiophyllic to convert sulphur crosslinks to sulphoxides and sulphones that devulcanizes the surface of the rubber particles. U.S. Pat. No. 4,161,464 describes the devulcanization of rubber particles after the swelling of the rubber with an organic solvent in an onium salt. U.S. Pat. No. 7,425,584 discloses a catalyst precursor dissolved in a solvent to swell the rubber. The solvent-swollen rubber is then heated in the presence of hydrogen to devulcanize the rubber. U.S. Pat. No. 9,982,107 discloses a devulcanizing agent for the selective destruction of sulfur bonds. The devulcanizing agent contains a mixture of triphenylphosphine (TPP) and 1,8 diazabicyclo[5.4.0]undec-7-ene (DBU). The mixture is extruded at temperatures from 40-120 C to introduce mechanical mastication of the rubber and produce devulcanized rubber. U.S. Pat. No. 7,767,722 discloses the use of natural and/or synthetic turpentine which can further comprise a solvent from a group consisting of lower aliphatic alcohols, lower alkanes and mixtures thereof. The reclaimed rubber and turpentine mixture are brought together at a temperature below 180 degrees C. and a pressure from about 4×10⁴ to 4×10⁵ pascals and mixed and agitated in a reactor vessel.

As can be discerned from the above discussion, the use of chemicals in rubber recycling and, specifically, devulcanization of rubber, is common in many devulcanization techniques. Given that rubber recycling is an environmental effort, it would be advantageous to create rubber that can be recycled without using such chemicals and, further, to provide consumer products made from chemical-free recycled rubber that perform at, or above, contemporary standards while using high loading rates (35%-70%) of recycled material in the final molded product.

As has been discussed, most modern techniques for recycling and devulcanization of rubber rely on chemicals in the devulcanization process. While the recycling of rubber is an environmental advantage, the use of chemicals involved in the recycling process detracts from the environmental advantage. It would be advantageous to produce products from recycled rubber without the use of chemicals. Disclosed herein is a rubber compound for articles, such as footwear outsoles, where the rubber is at least partially derived from recycled rubber. The recycled rubber used in such consumer products such as footwear outsoles is devulcanized without the use of chemicals. In some embodiments, a high-pressure water jet may be used to mechanically devulcanize the rubber without the use of chemicals as explained in Swiss Patent Application No. CH716478, the contents of which is hereby incorporated by reference in its entirety as if fully set forth herein. This mechanical devulcanization process may produce a desirable morphology of the recycled rubber particles that enables the rubber to be included in new products made with a combination of recycled rubber and virgin rubber. Specifically, the unique size, shape, and surface area to mass ratio of the preferred recycled rubber particles predispose it to forming vulcanized bonds with virgin rubber when producing new products via rubber molding.

By using such rubber particles, the resulting bonds between recycled and virgin rubber content may be relatively stronger and allow the final molded product to be created with a partially recycled compound in place of fully virgin rubber with physical properties (e.g., tensile, elongation, tear, abrasion), these properties being superior to conventional recycled rubber technology. For example, the improved physical properties of the recycled/virgin rubber mix may allow for more flexibility in the final mix of recycled and virgin material and still maintain the required physical properties. In some examples, a footwear outsole formed according to the disclosure may yield certain properties such as strength, durability, and traction to meet specifications based on the intended use of the particular footwear article. Using the instant disclosure, a recycled loading rate, which is defined as the percent of recycled rubber in the article by mass may be achieved (typically >20%) that is higher than the conventional threshold whereupon the physical properties start to deteriorate. Thus, the improved blending of recycled and virgin material with the current invention allows for high loading rate of recycle content while maintaining the intended physical properties for a footwear outsole and a resulting environmentally preferred rubber outsole.

When rubber is devulcanized via mechanical means, the resulting morphology of the rubber particles may help determine the level of re-vulcanization and the eventual quality of the re-vulcanized product. For example, a devulcanized rubber with a particle morphology with a high surface area-to-volume, or surface area-to-mass ratio may provide a greater surface for bonding. Moreover, the surface quality of the rubber can affect the bonding of devulcanized and virgin rubber. A variegated/rough surface creates a stronger interlock and a greater surface area for bonding.

In one example, the disclosure provides a process for creating footwear outsoles from an optimized recycled rubber where the recycled rubber is created without the use of chemicals. It is a further aspect of this disclosure to provide a formula for a rubber compound that works optimally with the disclosed recycled rubber morphology. It is also an aspect of the present disclosure to provide rubber formulas and a manufacturing process that, when used with a recycled rubber powder of a specific morphology, produce quality rubber consumer products and specifically footwear outsoles. It is further an aspect of the present disclosure to provide rubber formulas and a manufacturing process that, when using recycled rubber powder of a specific morphology, produces a rubber compound that works for footwear products where oil-resistant rubber is commonly needed. It is further an aspect of the present disclosure to provide a rubber formula and a manufacturing process that, when using recycled rubber powder of a specific morphology, produces a rubber compound that works with footwear commonly referred to as casual footwear, as well as hiking, dress, and athletic footwear.

In a preferred embodiment of the invention, recycled rubber is pulverized with a high-pressure water jet as described in patent CH716478 to a desired particle size. In some examples, the desired particle size is not more than 1000 micrometers. In some examples, the desired particle size is not less than 250 micrometers. In some examples, the desired particle size is between 250 micrometers and 1000 micrometers, or between 500 micrometers and 750 micrometers. The desired particles may also have a surface area to mass ratio of greater than 0.065 m²/g or greater than 0.080 m²/g (e.g., between 0.100 m²/g and 0.150 m²/g) and a variegated/rough surface. The rubber powder may be dried to a humidity of not more than 10% and mixed with virgin rubber to create the final compound. The rubber compound from the above formula may be compression molded and formed into an outsole suitable for use in footwear that is designated as oil and fuel resistant. This type of rubber is commonly required in many industrial jobs where a shoe's outsole comes in contact with oil and fuel.

In another preferred embodiment of the invention, recycled rubber is pulverized with a high-pressure water jet as described in patent No. CH 716478 A1 to a size of not more than 1000 micrometers and not less than 250 micrometers with a surface area to mass ratio of >0.08 m²/g and a variegated/rough surface. The rubber powder is dried to a humidity of not more than 10% RH and mixed with virgin rubber to create the final compound. The rubber compound from the above formula is compression molded and formed into a footwear outsole suitable for use in footwear that is designated as casual footwear. Examples of casual footwear include footwear from categories such as outdoor, outdoor casual, dress shoes, everyday shoes, slippers, and shoes suitable for hiking.

In one preferred embodiment, a rubber powder derived from recycled tires is used in a rubber formulation designed for use in the manufacturing of workplace footwear where fuel and oil resistance is important. The particles of the recycled rubber powder have a size generally less than 600 micrometers. The rubber powder is devulcanized without the use of chemicals using a mechanical process, and then mixed with additional materials and rubber types to produce a rubber that meets specifications for oil and fuel resistance rubber for use in footwear. Table 1 is the formula for the oil resistance rubber. The material percentages (PHR) are designed to optimize the physical characteristics of the final vulcanized rubber.

TABLE 1
Oil & Fuel Resistant Rubber Formula

| Item | Amount (PHR) | Notes |
|---|---|---|
| NBR Rubber | 82 | Nitril Rubber |
| Recycled Rubber Powder | 20 | <600 micrometers |
| BR9000 | 18 | |
| Silicon | 40 | |
| Zn0 | 4 | |
| Stearic Acid | 0.5 | |
| Wax RD | 1 | |
| PEG4000 | 3.6 | |
| Oil DODP | 3 | |
| Si69 Anti-abrasion | 3.5 | |
| SP-C anti-aging inhibitor | 1 | |
| C5 Resin | 1.5 | |

Referring now to FIG. 1. FIG. 1 describes the mixing and vulcanization procedure for creating a vulcanized (cured) rubber product or plaque sample to form oil and fuel resistant rubbers. The process steps and associating timing of each step produce a preferred vulcanized rubber with exceptional physical characteristics. In a first rubber mixing step 110, NBR is first added. BR+recycled rubber and NBR are then added, followed by Silicon & SI69, Silicon and oil, cleaning and homogenization. In a second step 120, the ingredients are mixed which includes heating, addition of an accelerant and homogenization. In step 130, a vulcanization process includes compression molding as shown in FIG. 1. One familiar with the rubber compounding process will understand that small variations in the mixing process can be applied and still produce a rubber of good quality.

A rubber compound made for casual footwear has different requirements than a compound designed for oil and fuel resistance. Table 2 lists the formula for casual rubber. The process chart for mixing a casual rubber compound is in FIG. 2 and generally includes three groups or steps: a rubber mixing step 210, a second rubber mixing step 220 and a vulcanization step 230.

TABLE 2
Casual Rubber formula

| Item | Amount (PHR) g | Notes |
|---|---|---|
| Recycled Rubber Powder | 3000 | <600 micrometer particle |
| Natural Rubber | 200 | Nitril Rubber |
| BR9000 | 3000 | |
| Silica | 1400 | |
| Silane Si69 | 200 | |
| Zn0 | 155 | |
| Stearic Acid | 38 | |
| PEG4000 | 140 | |
| Wax | 30 | |
| Oil | 100 | |
| Resin | 80 | |
| Soluble Polybutadiene | 600 | |
| DM | 60 | |
| QH | 60 | |

The morphology of particles is an important factor when mixing and combining elements together to form a compound. One can imagine that when different elements are mixed together, the shape, size, and wall properties of the elements play an important role in how well the elements join together. As the rubber compound is formed, the strength of the joining elements provides many of the qualities necessary to create a material with the optimal strength, resiliency, and molding capabilities.

FIG. 3A depicts the shape and size of a standard reclaimed rubber particle derived from standard cryogenic or mechanical devulcanization processes. FIG. 3B shows the shape and size of a preferred rubber particle of a higher surface area to mass ratio as well as a more variegated surface. As one skilled in the art can see, the preferred rubber particle exposes more surface for the same volume and enhances the bonding capabilities of this preferred recycled rubber particle with virgin rubber particles. The enhanced bonding capabilities improves the overall performance of the final rubber compound with improved elongation, tear strength, and tensile strength.

Table 3 compares the final material properties of a rubber compound made with standard particle profiles and a profile of a preferred compound with an enhanced morphology.

Table 3 shows the physical properties that can be achieved when using a 50% recycled content loading rate with the preferred recycled rubber. Of particular importance is that rubber particles of high surface area to mass ratio will join with virgin rubber more tightly and uniformly as compared to a more standard recycled rubber. The improved joining of rubber particles produces a rubber compound that when vulcanized into a footwear outsole produces a high-quality rubber with good physical properties. The improved physical properties allow the rubber to be compounded at high recycled loading rates that can be greater than 50% and still provide excellent quality. Specifically, in order to achieve the physical properties noted in Table 3, below, a conventional recycled article would be limited to a recycled loading rate of approximately 10%. As one skilled in rubber development for footwear will know, the below parameters will produce a footwear outsole that will perform appropriately for casual footwear with good strength and durability. And that can include up to 50% recycled content while maintaining industry physical property standards.

TABLE 3
Standard vs Enhanced Rubber Compound

| | Enhanced Compound | Standard Compound |
|---|---|---|
| | (50% Recycled | (10% Recycled |
| Physical Property | Content) | Content) |
| Tensile Strength (kg/cm) | 120 | 120 |
| Elongation (%) | 400 | 400 |
| Tear Strength (kg/cm²) | 100 | 100 |
| Traction (COF) | 0.35 | 0.35 |
| Abrasion (DIN) | 150 | 150 |

While the final rubber compound, vulcanized into a footwear outsole with a high level or recycled content is an important factor of this patent disclosure, the introduction of a masterbatch rubber with a high recycled content that can be easily incorporated into a final rubber compound is also important. A rubber masterbatch is a pre-mixture of rubber and other components that allows for easy handling of the material and the ability to incorporate the rubber into many different manufacturing settings without complicated rubber machinery. A masterbatch mix uses less materials than the final rubber compound and produces rubber in sheet form. This sheet of pre-mixed rubber is much easier to handle in a manufacturing setting as compared to a rubber powder and requires less machines. Additionally, the masterbatch will not create any airborne dust that is likely with a small particle size, lightweight powder.

Rubber masterbatch sheets made with a high percentage of recycled content would be desirable and these may include a recycled rubber that easily mixes and incorporates into a sheet when mixed with another polymer.

Table 4 lists the formula for a rubber masterbatch that can be used to form a footwear outsole when mixed with other chemicals and vulcanized and molded into the shape of a footwear outsole.

TABLE 4

| | Parts per Hundred | |
|---|---|---|
| Material | Rubber (PHR) | % Volume |
| Recycled Rubber Powder | 670 | 67 |
| Styrene-Butadien Rubber (SBR) | 300 | 30 |
| Mixing Oil | 30 | 3 |

One familiar in the art of rubber compounding will know that the virgin rubber polymer (in this case SBR) may be replaced with various other rubber polymers to achieve a different rubber masterbatch that will make it appropriate for the final rubber compound. For instance, if an oil resistant rubber is desired, the masterbatch might use Nitril-Butadien rubber (NBR) to help achieve better oil resistance. Other rubber polymers and combinations of rubber polymers can be substituted for the above SBR depending on the desired properties of the final rubber compound. The percentage of recycled rubber powder can vary and still be within the scope of this invention. Lower percentages of recycled rubber powder will make it easier to produce a consistent masterbatch and higher percentages will make it more difficult.

Once the desired masterbatch is mixed and extruded into sheet form, it should have physical properties close to those listed in Table 5. These physical properties are appropriate for a masterbatch rubber but will have lower specifications than is required for a final outsole rubber compound. The remaining material characteristics will for the final outsole will come during final compounding and vulcanization.

TABLE 5
Masterbatch Physical Properties

| Physical Property | Values |
|---|---|
| Hardness (Shore A) | 50-55 |
| Tensile Strength (kg/cm) | >40 |
| Elongation (%) | >300 |
| Tear Strength (kg/cm²) | >20 |
| Abrasion (DIN) | <375 |

It will be appreciated that the various dependent claims and the features set forth therein can be combined in different ways than presented in the initial claims. It will also be appreciated that the features described in connection with individual embodiments may be shared with others of the described embodiments.

What is claimed:

1. A footwear outsole, comprising:
a virgin rubber; and
a recycled rubber formed of recycled rubber particles, the recycled rubber content loading rate being greater than 15%.

2. The footwear outsole of claim 1, wherein the recycled rubber particles are between 250 and 1000 micrometers in size.

3. The footwear outsole of claim 1, wherein the recycled rubber particles have a surface area-to-mass ratio of greater than 0.065 m²/g.

4. The footwear outsole of claim 2, wherein the recycled rubber particles have a surface area-to-mass ratio of greater than 0.08 m²/g.

5. The footwear outsole of claim 1, wherein the recycled rubber particles have a surface area-to-mass ratio of between 0.100 m²/g and 0.150 m²/g.

6. The footwear outsole of claim 1, wherein the outsole has a tensile strength of greater than 120 kg/cm².

7. The footwear outsole of claim 1, wherein the outsole has an elongation percentage of greater than 400%.

8. The footwear outsole of claim 1, wherein the outsole has a tear strength of greater than 100 kg/cm.

9. The footwear outsole of claim 1, wherein the outsole has a traction coefficient of friction of greater than 0.35.

10. The footwear outsole of claim 1, wherein the outsole has abrasion DIN value of greater than 150.

11. The footwear outsole of claim 1, wherein the recycled rubber content loading rate is between 25% and 65%.

12. A method of manufacturing a footwear outsole, comprising:
providing a virgin rubber; and
mixing a recycled rubber formed of recycled rubber particles, the recycled rubber content loading rate being greater than 15%.

13. The method of claim 12, wherein mixing a recycled rubber comprises obtaining the recycled rubber and mechanically devulcanizing the recycled rubber via a high-pressure water jet.

14. The method of claim 12, wherein mechanically devulcanizing the recycled rubber via a high-pressure water jet excludes the addition of chemicals.

15. The method of claim 1, wherein the recycled rubber particles have a surface area-to-mass ratio of greater than 0.065 m²/g.

16. The method of claim 1, wherein the recycled rubber content loading rate is between 25% and 65%.

17. A method of manufacturing a footwear outsole, comprising:
providing a virgin rubber;
obtaining recycled rubber and mechanically devulcanizing the recycled rubber via a high-pressure water jet to form recycled rubber particles;
mixing the recycled rubber particles with virgin rubber, the recycled rubber content loading rate being greater than 15%.

18. The method of claim 17, wherein the recycled rubber content loading rate is greater than 40%.

19. A rubber masterbatch comprising:
a recycled rubber powder;
a Styrene-Butadien Rubber; and
a mixing oil.

20. The rubber masterbatch of claim 19, wherein the recycled rubber powder is 670 parts per hundred rubber, the Styrene-Butadien Rubber is 300 parts per hundred rubber, and the mixing oil is 30 parts per hundred rubber.
